(19) United States
(12) Patent Application Publication
(10) Pub. No.: US 2023/0111616 A1
(43) Pub. Date: Apr. 13, 2023

(54) THERMOSENSITIVE RECORDING MEDIUM, METHOD FOR PRODUCING THERMOSENSITIVE RECORDING MEDIUM, AND ARTICLE

(71) Applicants: Kazuhiro Morimoto, Shizuoka (JP); Kazuyuki Uetake, Shizuoka (JP)

(72) Inventors: Kazuhiro Morimoto, Shizuoka (JP); Kazuyuki Uetake, Shizuoka (JP)

(73) Assignee: Ricoh Company, Ltd., Tokyo (JP)

(21) Appl. No.: 17/905,761

(22) PCT Filed: Mar. 3, 2021
(86) PCT No.: PCT/JP2021/008081

§ 371 Date: Sep. 6, 2022

(30) Foreign Application Priority Data
Mar. 19, 2020 (JP) 2020-049930

(51) Int. Cl. B41M 5/28

(52) U.S. Cl. CPC B41M 5/28

(57) ABSTRACT

A thermosensitive recording medium includes a support, and a thermosensitive recording layer disposed on or above the support, wherein the thermosensitive recording layer includes a non-phenolic color developer and a sensitizer that includes fatty acid amide, and wherein an amount of the fatty acid amide in the sensitizer is 60% by mass or greater.

### TECHNICAL FIELD

The present disclosure relates to a thermosensitive recording medium, a method for producing a thermosensitive recording medium, and an article.

### BACKGROUND ART

A thermosensitive recording method using thermosensitive recording media has advantages that processes, such as developing and fixing, are not necessary, recording can be performed within a short period of time using a relatively simple device, and cost thereof is low, compared with other recording methods. Therefore, the thermosensitive recording media is widely used in various fields, such as a POS field for fresh food products, packed meals, and premade meals; a copying field for books and documents; a telecommunication field, such as facsimiles; a ticketing field for ticket machines, and receipts; and packaging tags for the aviation industry.

As a color developer used in a thermosensitive recording medium, a phenolic color developer having excellent preservability of background and an image and excellent coloring sensitivity, such as 4,4′-isopropylidenediphenol, has been widely used. However, there is a concern that the phenolic color developer may be an endocrine disruptor. In recent years, there has therefore been a demand for a thermosensitive recording medium using a color developer free from a phenol skeleton (may be referred to as a “non-phenolic color developer” hereinafter) in view of environmental issues.

Proposed as a thermosensitive recording medium using a non-phenolic color developer is a thermosensitive recording material, which includes a support, a thermosensitive recording layer including a non-phenolic color developer, and an underlying layer disposed between the support and the thermosensitive recording layer and including at least one sizing agent selected from the group consisting of an anionic styrene-acryl copolymer resin, and a styrene-maleic copolymer resin (see, for example, PTL 1).

Moreover, proposed is a thermosensitive recording medium, which includes a support, and a thermosensitive recording layer disposed on the support, and including at least a leuco dye and a color developer, where the color developer includes a nonphenolic color developer, and the thermosensitive recording layer further includes a specific sensitizer and saturated fatty acid amide (see, for example, in PTL 2).

### CITATION LIST

### Patent Literature

PTL 1: Japanese Unexamined Patent Application Publication No. 2015-150764

PTL 2: Japanese Unexamined Patent Application Publication No. 2014-226848

### SUMMARY OF INVENTION

### Technical Problem

The present disclosure has an object to provide a thermosensitive recording medium that is free from a phenol-based color developer that may be determined as an endocrine disruptor, has high coloring sensitivity, and has excellent coloring sensitivity after storage over time.

### Solution to Problem

According to one aspect of the present disclosure, a thermosensitive recording medium includes a support, and a thermosensitive recording layer disposed on or above the support. The thermosensitive recording layer includes a non-phenolic color developer and a sensitizer that includes fatty acid amide. An amount of the fatty acid amide in the sensitizer is 60% by mass or greater.

### Advantageous Effects of Invention

The present disclosure can provide a thermosensitive recording medium that is free from a phenol-based color developer that may be determined as an endocrine disruptor, has high coloring sensitivity, and has excellent coloring sensitivity after storage over time.

### DESCRIPTION OF EMBODIMENTS

(Thermosensitive Recording Medium)

The thermosensitive recording medium of the present disclosure includes a support and a thermosensitive recording layer disposed on or above the support. The thermosensitive recording medium preferably further includes an adhesive layer, a release layer, and a protective layer, and may further include other layers according to the necessity.

In the art, a relationship between an amount of fatty acid amide serving as a sensitizer included in the thermosensitive recording layer with coloring sensitivity of the thermosensitive recording medium or coloring sensitivity thereof after storage over time has not been made clear, and there is a problem that coloring sensitivity of a thermosensitive recording medium and coloring sensitivity thereof after storage over time are not sufficient.

The present inventors have found that the following thermosensitive recording layer is free from a phenol-based color developer that may be determined as an endocrine disruptor, but has high coloring sensitivity and has excellent coloring sensitivity after storage over time. That is, the thermosensitive recording medium includes a support, and a thermosensitive recording layer disposed on or above the support, where the thermosensitive recording layer includes a non-phenolic color developer and a sensitizer that includes fatty acid amide, and an amount of the fatty acid amide in the sensitizer is 60% by mass or greater.

<Thermosensitive Recording Layer>

The thermosensitive recording layer includes a color developer and a sensitizer, preferably further includes a leuco dye and a binder resin, and may further include other components according to the necessity.

—Color Developer—

The color developer is a non-phenolic color developer. The term “non-phenolic” means that a phenol skeleton is not included. Use of the non-phenolic color developer can replace a phenol-based color developer that may be determined as an endocrine disruptor, and therefore a resultant thermosensitive recording medium is excellent in view of environmental friendliness.

It has been known that the variety of the non-phenolic color developer is smaller than the variety of the phenol-based color developer. Examples of the non-phenolic color developer include a compound represented by General Formula (1) below, a compound represented by General Formula (2) below, a compound represented by General Formula (3) below, a compound represented by General Formula (4) below, a compound represented by General Formula (5) below, a compound represented by General Formula (6) below, a compound represented by General Formula (7) below, a compound represented by General Formula (8) below, a compound represented by General Formula (9) below, a compound represented by General Formula (10) below, and a compound represented by General Formula (11) below. Among the above-listed examples, 4-methyl-N-[[[3-[[(4-methylphenyl)sulfonyl]oxy]phenyl]amino]carbonyl]benzenesulfonamide, N-[2-[[(phenylamino)carbonyl]amino]phenyl]benzenesulfonamide, N-[2-(3-phenylureido)phenyl]benzenesulfonamide, and a compound represented by General Formula (1) below are preferable.

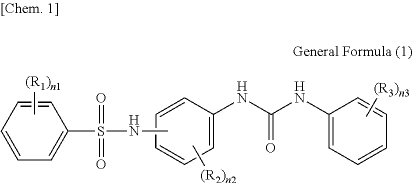

(General Formula (1), R₁ to R₃ are each a hydrogen atom, a halogen atom, a nitro group, a C₁-C₆ alkyl group, a C₁-C₆ alkoxy group, a C₂-C₆ alkenyl group, a C₁-C₆ fluoroalkyl group, N(R₄)₂ group (R₄ is a hydrogen atom, a phenyl group, a benzyl group, or a C₁-C₆ alkyl group), NHCOR, (R, is a C₁-C₆ alkyl group), a phenyl group that may be substituted, or a benzyl group that may be substituted; n₁ and n₃ are each independently an integer of from 1 through 5; and n₂ is an integer of from 1 through 4)

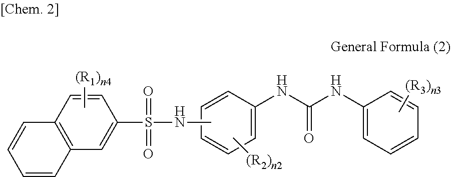

(In General Formula (2), R₁ to R₃ are identical to R₁ to R₃ of General Formula (1), n₂ and n₃ are identical to n₂ and n₃ of General Formula (1), and n₄ is an integer of from 1 through 7.)

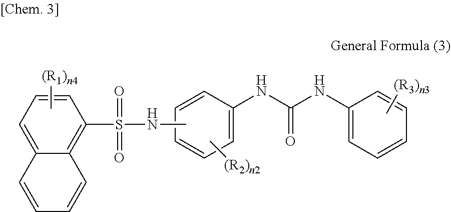

(In General Formula (3), R₁ to R₃ are identical to R₁ to R₃ of General Formula (1), and n₂, n₃ and n₄ are identical to n₂, n₃ and n₄ of General Formula (1) and General Formula (2).)

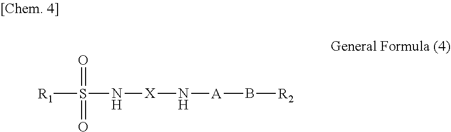

(In General Formula (4), R₁ is an unsubstituted or substituted phenyl, naphthyl, or C₁-C₂₀ alkyl group; X is a group represented by —C═NH—, —CS—, or —CO—; A is an unsubstituted or substituted phenylene, naphthylene, or C₁-C₁₂ alkylene group, or an unsubstituted or substituted heterocycle group; B is a linking group of —O—SO₂—, —SO₂—O—, —NH—SO₂—, —SO₂—NH—, —S—SO₂—, —O—CO—, —O—CO—NH—, —NH—CO—, —NH—CO—O—, —S—CO—NH—, —S—CS—NH—, —CO—NH—SO₂—, —O—CO—NH—SO₂—, —NH═CH—, —CO—NH—CO—, —S—, —CO—, —O—, —SO₂—NH—CO—, —O—CO—O—, or —O—PO—(OR₂)₂; and R₂ is an unsubstituted or substituted aryl, benzyl, or C₁-C₂₀ alkyl group, and when B is not a linking group of —O—SO₂—, R₂ is an unsubstituted or substituted phenyl, naphthyl, or C₁-C₈ alkyl group.)

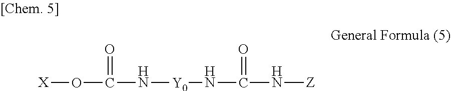

(In General Formula (5), X and Z are each independently an aromatic compound residue, a heterocycle compound residue, or a aliphatic compound residue, where each residue may include a substituent; and Y₀ is at least one selected from the group consisting of a tolylene group, a xylylene group, a naphthylene group, a hexamethylene group, and a -φ—CH₂-φ- group, where -φ- is a phenylene group.)

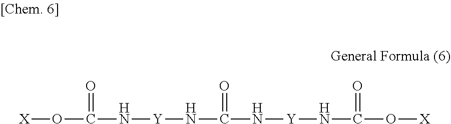

(In General Formula (6), X and Y are each independently an aromatic compound residue, a heterocycle compound residue, or an aliphatic compound residue, where each residue may include a substituent.)

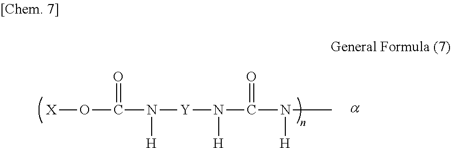

(In General Formula (7), X and Y are each independently an aromatic compound residue, a heterocycle compound residue, or an aliphatic compound residue; α is a divalent or higher residue; and n is an integer of 2 or greater, where each residue may include a substituent.)

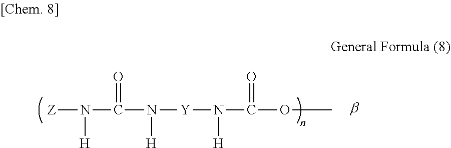

(In General Formula (8), Z and Y are each independently an aromatic compound residue, a heterocyclic compound residue, or an aliphatic compound residue; β is a bivalent or higher residue; and n is an integer of 2 or greater, where each residue may include a substituent.)

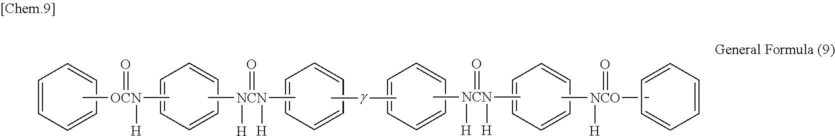

(In General Formula (9), a hydrogen atom of a benzene ring may be substituted with an aromatic compound residue, an aliphatic compound residue, or a heterocyclic compound residue, where each residue may include a substituent; γ is at least one selected from the group consisting of —SO₂—, —O—, —(S)ₙ—, —(CH₂)ₙ—, —CO—, —CONH—, —O—φ—C(CH₃)₂-φ—O—, —C(CH₃)₂-φ—C(CH₃)₂—, —O-φ—O—, —O-φ-φ—O—, and —O-φ—SO₂-φ-, or does not exist; and n is 1 or 2.)

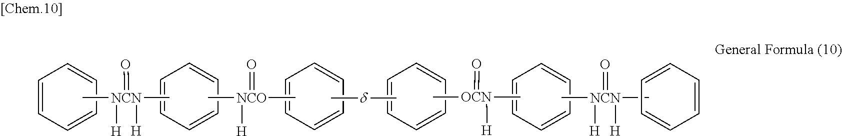

(In General Formula (10), a hydrogen atom of a benzene ring may be substituted with an aromatic compound residue, an aliphatic compound residue, or a heterocyclic compound residue, where each residue may include a substituent; δ is at least one selected from the group consisting of —SO₂—, —O—, —(S)ₙ—, —(CH₂)ₙ—, —CO—, —CONH—, —NH—, —CH(COOR₁)—, —C(CF₃)₂—, and —CR₂R₃—, or does not exist; R₁, R₂, and R₃ are each an alkyl group; and n is 1 or 2.)

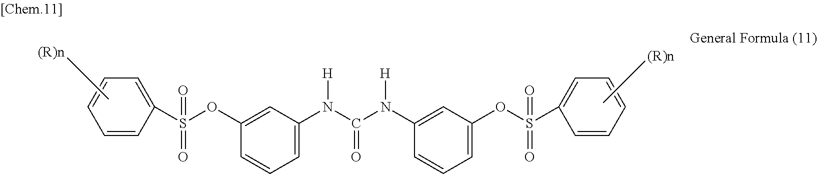

(In General Formula (11), R is an alkyl group, and n is an integer of from 0 through 3.)

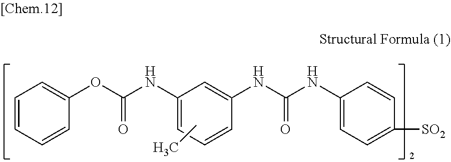

The non-phenolic color developer may be appropriately synthesized for use, or selected from commercial products. Examples of the commercial products thereof include UU (the compound represented by Structural Formula (1), available from Chemipro Kasei Kaisha, Ltd.), Pergafast 201

(4-methyl-N-[[[3-[[(4-methylphenyl)sulfonyl]oxy]phenyl]amino]carbonyl]benzenesulfonamide, available from BASF), and NKK-1304
(N-[2-[[(phenylamino)carbonyl]amino]phenyl]benzenesulfonamide, available from Nippon Soda Co., Ltd.).

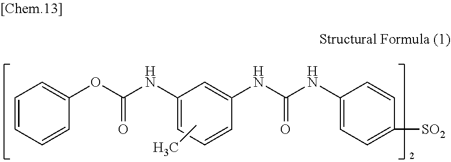

An amount of the color developer is not particularly limited and may be appropriately selected depending on the intended purpose. The amount of the color developer is preferably 1 part by mass or greater but 20 parts by mass or less, and 2 parts by mass or greater but 10 parts by mass or less, relative to 1 part by mass of the leuco dye.

—Sensitizer—

The sensitizer includes fatty acid amide, and may further include another sensitizer that is not fatty acid amide according to the necessity. Since the sensitizer is included in the thermosensitive recording layer, coloring sensitivity of the non-phenolic color developer can be improved. Particularly, coloring sensitivity of the non-phenolic color developer can be improved even more by using fatty acid amide as the sensitizer. In the case where the thermosensitive recording medium includes an adhesive layer, moreover, a phenomenon that improvement of coloring sensitivity is inhibited by the adhesive component in the adhesive layer can be prevented.

Examples of the fatty acid amide include fatty acid monoamide, and fatty acid bisamide. Among the above-listed examples, fatty acid monoamide is preferable because use of the fatty acid monoamide can realize a thermosensitive recording medium having excellent coloring sensitivity.

Examples of the fatty acid monoamide include stearic acid amide, palmitic acid amide, arachidonic acid amide, behenic acid amide, N-benzoyl stearic acid amide, N-methylol stearic acid amide, lauric acid amide, oleic acid amide, erucic acid amide, hydroxystearic acid amide, and N,N′-distearyl adipic acid amide. The above-listed examples may be used alone or in combination.

Examples of the fatty acid bisamide include ethylene bis(stearic acid amide), methylene bis(stearic acid amide), ethylene bis(capric acid amide), ethylene bis(lauric acid amide), ethylene bis(hydroxystearic acid amide), ethylene bis(behenic acid amide), hexamethylene bis(stearic acid amide), hexamethylene bis(behenic acid amide), and hexamethylene bis(hydroxystearic acid amide). The above-listed examples may be used alone or in combination.

The sensitizer may be appropriately synthesized for use, or selected from commercial products. Examples of the commercial products include AP-1 (stearic acid amide, available from Mitsubishi Chemical Corporation), L271 (stearic acid amide emulsion, available from CHUKYO YUSHI CO., LTD.), DIAMID KP (palmitic acid amide, available from Mitsubishi Chemical Corporation), DIAMID KH (hydroxystearic acid amide, available from Mitsubishi Chemical Corporation), and G110 (ethylene bis(stearic acid amide) emulsion, available from CHUKYO YUSHI CO., LTD.). Among the above-listed examples, AP-1, L271, DIAMID KP, and DIAMID KH, which are fatty acid monoamides, are preferable because a thermosensitive recording medium having excellent coloring sensitivity can be obtained.

An amount of the fatty acid amide in the sensitizer is 60% by mass or greater, and preferably 80% by mass or greater. When the amount of the fatty acid amide is 60% by mass or greater, a thermosensitive recording medium having excellent coloring sensitivity can be obtained, and moreover a thermosensitive recording medium having excellent coloring sensitivity after storage over time can be obtained.

An amount of the fatty acid amide in the thermosensitive recording layer is preferably 0.1% by mass or greater, and more preferably 1% by mass or greater. When the amount thereof is 1% by mass or greater, a thermosensitive recording medium having excellent coloring sensitivity can be obtained, and moreover a thermosensitive recording medium having excellent coloring sensitivity after storage over time can be obtained.

—Sensitized that is not Fatty Acid Amide—

The sensitizer that is not fatty acid amide is not particularly limited and may be appropriately selected depending on the intended purpose. Examples thereof include diphenyl sulfone, oxalic acid bis(p-methylbenzyl) ester, 1,2-bis(3-methylphenoxy)ethane, 1,2-diphenoxyethane, and 2-benzoyloxynaphthalene. The sensitizer that is not fatty acid amide may be appropriately synthesized for use or selected from commercial products. Examples of the commercial products include DPS (diphenyl sulfone, available from UCB Japan Co., Ltd.), ST-LC (bis(p-methylbenzyl)oxalate, available from Union), KS-232 (1,2-bis(3-methylphenoxy)ethane, available from SANKO CO., LTD.), KS-235 (1,2-diphenoxyethane, available from SANKO CO., LTD.), and BON (2-benzyloxynaphthalene, available from Cameleon).

An amount of the sensitizer that is not fatty acid amide in a total amount of the sensitizer is less than 40% by mass, and preferably less than 20% by mass. When the amount thereof is less than 40% by mass, a thermosensitive recording medium having excellent coloring sensitivity can be obtained, and moreover a thermosensitive recording medium having excellent coloring sensitivity after storage over time can be obtained.

—Leuco Dye—

The leuco dye is not particularly limited and may be appropriately selected among leuco dyes used for thermosensitive recording media depending on the intended purpose. Examples thereof include leuco compounds, such as triphenylmethane-based dyes, fluoran-based dyes, phenothiazine-based dyes, auramine-based dyes, spiropyranbased dyes, and indolinophthalide-based dyes.

The leuco dye is not particularly limited and may be appropriately selected depending on the intended purpose. Examples thereof include 3,3-bis(p-dimethylaminophenyl)-phthalide, 3,3-bis(p-dimethylaminophenyl)-6-dimethylaminophthalide (also known as crystal violet lactone), 3,3-bis(p-dimethylaminophenyl)-6-diethylaminophthalide, 3,3-bis(p-dimethylaminophenyl)-6-chlorophthalide, 3,3-bis(p-dibutylaminophenyl)phthalide, 3-cyclohexylamino-6-chlorofluoran, 3-dimethylamino-5,7-dimethylfluoran, 3-diethylamino-7-chlorofluoran, 3-diethylamino-7-methylfluoran, 3-diethylamino-7,8-benzfluoran, 3-diethylamino-6-methyl-7-chlorofluoran, 3-(N-p-tolyl-N-ethylamino)-6-methyl-7-anilinofluoran, 2-{N-(3′-trifluoromethylphenyl)amino}-6-diethylaminofluoran, 2-{3,6-bis(diethylamino)-9-(o-chloroanilino)xanthyl lactam benzoate}, 3-diethylamino-6-methyl-7-(m-trichloromethylanilino)fluoran, 3-diethylamino-7-(o-chloroanilino)fluoran, 3-pyrrolidino-6-methyl-7-anilinofluoran, 3-di-n-butylamino-7-o-chloroanilino)fluoran, 3-N-methyl-N,n-amylamino-6-methyl-7-anilinofluoran, 3-N-methyl-N-cyclohexylamino-6-methyl-7-anilinofluoran, 3-diethylamino-6-methyl-7-anilinofluoran, 3-(N,N-diethylamino)-5-methyl-7-(N,N-dibenzylamino)fluoran, benzoyl leuco methylene blue, 6′-chloro-8′-methoxy-benzoindolino-spiropyran, 6′-bromo-3′-methoxy-benzoindolino-spiropyran, 3-(2′-hydroxy-4′-dimethylaminophenyl)-3-(2′-methoxy-5′ chlorophenyl)phthalide, 3-(2′-hydroxy-4′-dimethylaminophenyl)-3-(2′-methoxy-5′-nitrophenyl)phthalide, 3-(2′-hydroxy-4′-diethylaminophenyl)-3-(2′-methoxy-5′-methylphenyl)phthalide, 3-(2′-methoxy-4′-dimethylaminophenyl)-3-(2′-hydroxy-4′-chloro-5′-methylphenyl)phthalide, 3-(N-ethyl-N-tetrahydrofurfuryl)amino-6-methyl-7-anilinofluoran, 3-N-ethyl-N-(2-ethoxypropyl)amino-6-methyl-7-anilinofluoran, 3-N-methyl-N-isobutyl-6-methyl-7-anilinofluoran, 3-morpholino-7-(N-propyl-trifluoromethylanilino)fluoran, 3-pyrrolidino-7-trifluoromethylanilinofluoran, 3-diethylamino-5-chloro-7-(N-benzyl-trifluoromethylanilino)fluoran, 3-pyrrolidino-7-(di-p-chlorophenyl)methylaminofluoran, 3-diethylamino-5-chloro-7-(α-phenylethylamino)fluoran, 3-(N-ethyl-p-toluidino)-7-(α-phenylethylamino)fluoran, 3-diethylamino-7-(o-methoxycarbonylphenylamino)fluoran, 3-diethylamino-5-methyl-7-(α-phenylethylamino)fluoran, 3-diethylamino-7-piperidinofluoran, 2-chloro-3-(N-methyltoluidino)-7-(p-n-butylanilino)fluoran, 3-di-n-butylamino-6-methyl-7-anilinofluoran, 3,6-bis(dimethylamino)fluorene spiro (9,3′)-6′-dimethylaminophthalide, 3-(N-benzyl-N-cyclohexylamino)-5,6-benz-7-α-naphthylamino-4′-bromofluoran, 3-diethylamino-6-chloro-7-anilinofluoran, 3-diethylamino-6-methyl-7-mesitidino-4′,5′-benzfluoran, 3-N-methyl-N-isopropyl-6-methyl-7-anilinofluoran, 3-N-ethyl-N-isoamyl-6-methyl-7-anilinofluoran, 3-diethylamino-6-methyl-7-(2′,4′-dimethylanilino)fluoran, 3-morpholino-7-(N-propyl-trifluoromethylanilino)fluoran, 3-pyrrolidino-7-trifluoromethylanilinofluoran, 3-diethylamino-5-chloro-7-(N-benzyl-trifluoromethylanilino)fluoran, 3-pyrrolidino-7-(di-p-chlorophenyl)methylaminofluoran, 3-diethylamino-5-chloro-(α-phenylethylamino)fluoran, 3-(N-ethyl-p-toluidino)-7-(α-phenylethylamino)fluoran, 3-diethylamino-7-(o-methoxycarbonylphenylamino)fluoran, 3-diethylamino-5-methyl-7-(α-phenylethylamino)fluoran, 3-diethylamino-7-piperidinofluoran, 2-chloro-3-(N-methyltoluidino)-7-(p-N-butylanilino)fluoran, 3,6-bis(dimethylamino)fluorene spiro (9,3′)-6′-dimethylaminophthalide, 3-(N-benzyl-N-cyclohexylamino)-5,6-benzo-7-α-naphthylamino-4′-bromofluoran, 3-diethylamino-6-chloro-7-anilinofluoran, 3-N-ethyl-N—(−2-ethoxypropyl)amino-6-methyl-7-anilinofluoran, 3-N-ethyl-N-tetrahydrofurfrylamino-6-methyl-7-anilinofluoran, 3-diethylamino-6-methyl-7-mesitidino-4′,5′-benzofluoran, 3-p-dimethylaminophenyl)-3-{1,1-bis(p-dimethylaminophenyl)ethylen-2-yl}phthalide, 3-(p-dimethylaminophenyl)-3-{1,1-bis(p-dimethylaminophenyl)ethylen-2-yl}-6-dimethylaminophthalide, 3-(p-dimethylaminophenyl)-3-(1-p-dimethylaminophenyl-1-phenylethylen-2-yl)phthalide, 3-(p-dimethylaminophenyl)-3-(1-p-dimethylaminophenyl-1-p-chlorophenylethylen-2-yl)-6-dimethylaminophthalide, 3-(4′-dimethylamino-2′-methoxy)-3-(1″-p-dimethylaminophenyl-1″-p-chlorophenyl-1″,3″-butadien-4″-yl)benzophthalide, 3-(4′-dimethylamino-2′-benzyloxy)-3-(1″-p-dimethylaminophenyl-1″-phenyl-1″,3″-butadien-4″-yl)benzophthalide, 3-dimethylamino-6-dimethylamino-fluorene-9-spiro-3′-(6′-dimethylamino)phthalide, 3,3-bis(2-(p-dimethylaminophenyl)-2-p-methoxyphenyl)ethenyl)-4,5,6,7-tetrachlorophthalide, 3-bis{1,1-bis(4-pyrrolidinophenyl)ethylen-2-yl}-5,6-dichloro-4,7-dibromophthalide, bis(p-dimethylaminostyryl)-1-naphthalenesulfonylmethane, and bis(p-dimethylaminostyryl)-1-p-tolylsulfonylmethane. The above-listed examples may be used alone or in combination.

—Binder Resin—

The binder resin is not particularly limited and may be appropriately selected depending on the intended purpose. Examples thereof include: a polyvinyl alcohol resin: starch and derivatives thereof; cellulose derivatives, such as hydroxymethyl cellulose, hydroxyethyl cellulose, carboxymethyl cellulose, methyl cellulose, and ethyl cellulose; water-soluble polymers, such as sodium polyacrylate, polyvinyl pyrrolidone, acrylamide-acrylic acid ester copolymers, acrylamide-acrylic acid ester-methacrylic acid terpolymers, styrene-maleic anhydride copolymer alkali salts, isobutylene-maleic anhydride copolymer alkali salts, polyacrylamide, sodium alginate, gelatin, and casein; emulsions of, for example, polyvinyl acetate, polyurethane, polyacrylic acid, polyacrylic acid ester, vinyl chloride-vinyl acetate copolymers, polybutyl methacrylate, and ethylene-vinyl acetate copolymers; and latexes of, for example, styrene-butadiene copolymers and styrene-butadiene-acrylic copolymers. The above-listed examples may be used alone or in combination. Among the above-listed examples, a styrenebutadiene copolymer (SBR) is particularly preferable in order to improve water resistance.

—Other Components—

Other components are not particularly limited and may be appropriately selected depending on the intended purpose. Examples thereof include an auxiliary additive, a surfactant, a lubricant, and filler.

As the auxiliary additive, for example, various hindered phenol compounds or hindered amine compounds having electron-accepting characteristics but relatively low coloring ability may be added. Specific examples thereof include 2,2′-methylenebis(4-ethyl-6-tert-butylphenol), 4,4′-butylidenebis(6-tert-butyl-2-methylphenol), 1,1,3-tris(2-methyl-4-hydroxy-5-tert-butylphenyl)butane, 1,1,3-tris(2-methyl-4-hydroxy-5-cyclohexylphenyl)butane, 4,4′-thiobis(6-tertiary butyl-2-methylphenol), tetrabromo bisphenol A, tetrabromo bisphenol S, 4,4-thiobis(2-methylphenol), 4,4′-thiobis(2-chlorophenol), tetrakis(1,2,2,6,6-pentamethyl-4-piperidyl)-1,2,3,4-butane tetracarboxylate, and tetrakis(1,2,2,6,6-tetramethyl-4-piperidyl)-1,2,3,4-butane tetracarboxylate.

Examples of the lubricant include higher fatty acid or metal salt of higher fatty acid, higher fatty acid amide, higher fatty acid ester, animal wax, vegetable wax, mineral wax, and petroleum wax.

Examples of the filler include: inorganic powder such as calcium carbonate, silica, silica, zinc oxide, titanium oxide, zirconium oxide, aluminum hydroxide, zinc hydroxide, barium sulfate, clay, kaolin, talc, surface-treated calcium, and surfacetreated silica; and organic powder such as a urea-formalin resin, a styrene-methacrylic acid copolymer, a polystyrene resin, and a vinylidene chloride resin.

The thermosensitive recording layer is not particularly limited and may be formed by a method known in the art. For example, the color developer and the leuco dye are pulverized and dispersed together with the binder resin and the above-mentioned other components by means of a disperser, such as a ball mill, an attritor, and a sand mill to achieve dispersed particle diameters of 0.1 micrometers or greater but 3 micrometers or less, followed by optionally mixing with the filler to prepare a thermosensitive recording layer coating liquid, and the thermosensitive recording layer coating liquid is applied onto a support and dried to thereby form a thermosensitive recording layer.

The coating method is not particularly limited and may be appropriately selected depending on the intended purpose. Examples of the coating method include blade coating, gravure coating, gravure offset coating, bar coating, roll coating, knife coating, air knife coating, comma coating, U-comma coating, AKKU coating, smoothing coating, microgravure coating, reverse roll coating, 4-roll or 5-roll coating, dip coating, curtain coating, slide coating, and die coating.

A deposition amount of the thermosensitive recording layer after drying is not particularly limited and may be appropriately selected depending on the intended purpose. The deposition amount thereof is preferably 1 g/m² or greater but 20 g/m² or less, and more preferably 2 g/m² or greater but 10 g/m² or less.

The average thickness of the thermosensitive recording layer is not particularly limited and may be appropriately selected depending on the intended purpose. The average thickness of the thermosensitive recording layer is preferably 1 micrometer or greater but 20 micrometers or less, and more preferably 2 micrometers or greater but 10 micrometers or less.

<Support>

The support is not particularly limited, and a shape, structure, size, and material thereof may be appropriately selected depending on the intended purpose. Examples of the shape thereof include a flat plate and a sheet. The structure thereof may be a single-layer structure, or a multi-layer structure. The size thereof may be appropriately selected depending on the size of the thermosensitive recording medium.

The material of the support is not particularly limited and may be appropriately selected depending on the intended purpose. Examples thereof include an inorganic material and an organic material.

Examples of the inorganic material include glass, quartz, silicon, silicon oxide, aluminium oxide, SiO₂, and metal.

Examples of the organic material include: paper, such as woodfree paper, art paper, coated paper, and synthetic paper; cellulose derivatives, such as cellulose triacetate; and plastic films, such as of a polyester resin (e.g., polyethylene terephthalate (PET), and polybutylene terephthalate), polycarbonate, polystyrene, polymethyl methacrylate, polyethylene, and polypropylene. The above-listed examples may be used alone or in combination.

The support is preferably subjected to surface modification for the purpose of improving the adhesion of the underlying layer. Examples of the surface modification include corona discharge, an oxidation treatment (e.g., chromic acid), etching, an easy adhesion treatment, and an antistatic treatment. Moreover, the support is preferably tinted in white by adding a white pigment, such as titanium oxide.

The average thickness of the support is not particularly limited and may be appropriately selected depending on the intended purpose. The average thickness of the support is preferably 20 micrometers or greater but 2,000 micrometers or less, and more preferably 50 micrometers or greater but 1,000 micrometers or less.

<Adhesive Layer>

The adhesive layer is a layer formed of an adhesive, and may further include other components according to the necessity. The adhesive layer is preferably disposed on a side of the support opposite to the side thereof at which the thermosensitive recording layer is disposed.

A known thermosensitive recording medium including an adhesive layer has a problem that coloring sensitivity of a sensitizer is not improved as an adhesion component included in the adhesive layer adversely affects the sensitizer included in the thermosensitive recording layer, and therefore coloring sensitivity of the thermosensitive recording medium is insufficient.

Since fatty acid amide is included in the thermosensitive recording layer as a sensitizer in the present disclosure, improvement of coloring sensitivity of the sensitizer is not inhibited even when the thermosensitive recording medium includes an adhesive layer, and therefore the thermosensitive recording medium having excellent coloring sensitivity is obtained.

A material of the adhesive layer is not particularly limited and may be appropriately selected depending on the intended purpose. Examples thereof include a urea resin, a melamine resin, a phenol resin, an epoxy resin, a vinyl acetate resin, a vinyl acetateacryl copolymer, an ethylene-vinyl acetate copolymer, an acrylic resin, a polyvinyl ether resin, a vinyl chloride-vinyl acetate copolymer, a polystyrene resin, a polyester resin, a polyurethane resin, a polyamide resin, a chlorinated polyolefin resin, a polyvinyl butyral resin, acrylic acid ester copolymers, methacrylic acid ester copolymers, natural rubber, a cyanoacrylate resin, and a silicone resin. The above-listed examples may be used alone or in combination.

—Other Components—

Other components are not particularly limited and may be appropriately selected depending on the intended purpose. Components identical to the components used in the adhesive layer can be used.

<Release Layer>

In case of a liner-less thermosensitive recording medium, a release layer is preferably disposed on the thermosensitive recording layer.

Examples of a release agent included in the release layer include a UV-curing silicone resin, a thermoset silicone resin, and a fluoro-release agent. The above-listed examples may be used alone or in combination. Among the above-listed examples, a UV-curing silicone resin is preferable as a curing speed is fast, and release stability is excellent over time.

Examples of the UV-curing silicone resin include a silicone resin cured by cationic polymerization, and a silicone resin cured by radical polymerization. In case of the silicone resin cured by radical polymerization, volumetric shrinkage occurs during curing to may curl a support.

A deposition amount of the release layer after drying is preferably 0.2 g/m² or greater but 2.0 g/m² or less. When the deposition amount thereof after drying is 0.2 g/m² or greater but 2.0 g/m² or less, appropriate release force is obtained, and paper jams during transferring the thermosensitive recording medium inside a printer can be prevented.

<Protective Layer>

The protective layer includes a binder resin and a crosslinking agent, and may further include other components according to the necessity. The protective layer is preferably disposed on the thermosensitive recording layer.

The binder resin is not particularly limited and may be appropriately selected depending on the intended purpose. The binder resin is particularly preferably a water-soluble resin.

Examples of the water-soluble resin include polyvinyl alcohol, modified polyvinyl alcohol, starch and derivatives thereof, cellulose derivatives (e.g., methoxycellulose, hydroxyethyl cellulose, carboxy methyl cellulose, methyl cellulose, and ethyl cellulose), sodium polyacrylate, polyvinyl pyrrolidone, acrylamide-acrylic acid ester copolymers, acrylamide-acrylic acid ester-methacrylic acid tercopolymers, alkali salts of styrene-maleic anhydride copolymers, alkali salts of isobutylene-maleic anhydride copolymers, polyacrylamide, modified polyacrylamide, methyl vinyl ether-maleic anhydride copolymers, carboxy-modified polyethylene, polyvinyl alcohol-acrylamide block copolymers, melamine-formaldehyde resins, urea-formaldehyde resins, sodium alginate, gelatin, and casein. The above-listed examples may be used alone or in combination. Among the above-listed examples, modified polyvinyl alcohol is preferable. Examples of the modified polyvinyl alcohol include diacetone-modified polyvinyl alcohol, acetoacetyl-modified polyvinyl alcohol, and carboxylic acid-modified polyvinyl alcohol, such as itaconic acid-modified polyvinyl alcohol, and maleic acid-modified polyvinyl alcohol.

The crosslinking agent is not particularly limited and may be appropriately selected depending on the intended purpose, as long as the crosslinking agent reacts with the water-soluble resin to decrease solubility of the water-soluble resin to water. Examples thereof include glyoxal derivatives, methylol derivatives, epichlorohydrin, polyamide epichlorohydrin, epoxy compounds, aziridine compounds, hydrazine, hydrazide derivatives, oxazoline derivatives, and carbodiimide derivatives. The above-listed examples may be used alone or in combination. Among the above-listed examples, polyamide epichlorohydrin is preferable because of high safety upon handling and a short curing time required for water resistance.

An amount of the polyamide epichlorohydrin is not particularly limited and may be appropriately selected depending on the intended purpose. The amount thereof is preferably 10 parts by mass or greater but 60 parts by mass or less, and more preferably 20 parts by mass or greater but 50 parts by mass or less, relative to 100 parts by mass of the binder resin.

Moreover, the protective layer optionally preferably includes a pigment (filler). Examples of the pigment used in the protective layer include: inorganic pigments, such as zinc oxide, calcium carbonate, barium sulfate, titanium oxide, lithopone, talc, agal-matolite, kaolin, aluminium hydroxide, and calcined kaolin; and organic pigments, such as a crosslinked polystyrene resin, a urea resin, a silicone resin, a crosslinked polymethyl methacrylate resin, and a melamine-formaldehyde resin.

In addition to the resin, water-proof agent, and pigment mentioned above, the protective layer may include auxiliary additive components known in the art. Examples of the auxiliary additive components include a surfactant, a thermoplastic material, a lubricant, and a pressure-coloring inhibitor.

The protective layer is not particularly limited and may be formed by any of methods known in the art.

The average thickness of the protective layer is not particularly limited and may be appropriately selected depending on the intended purpose. The average thickness of the protective layer is preferably 0.5 micrometers or greater but 5 micrometers or less, and more preferably 1 micrometer or greater but 3 micrometers or less.

<Other Layers>

Other layers are not particularly limited and may be appropriately selected depending on the intended purpose. Examples thereof include a backing layer, and an underlying layer.

—Backing Layer—

The backing layer may be optionally disposed at the side of the support where the thermosensitive recording layer is not disposed.

The backing layer includes filler and a binder resin, and may further include other components, such as a lubricant, and a color pigment, according to the necessity.

As the filler, for example, inorganic filler or organic filler can be used.

Examples of the inorganic filler include carbonate, silicate, metal oxide, and a sulfuric acid compound.

Examples of the organic filler include a silicone resin, cellulose, an epoxy resin, a nylon resin, a phenol resin, a polyurethane resin, a urea resin, a melamine resin, a polyester resin, a polycarbonate resin, a styrene resin, an acrylic resin, a polyethylene resin, a formaldehyde resin, and a polymethyl methacrylate resin.

The binder resin is not particularly limited and may be appropriately selected depending on the intended purpose. As the binder resin, for example, a binder resin identical to the binder resin of the thermosensitive recording layer may be used. The average thickness of the backing layer is not particularly limited and may be appropriately selected depending on the intended purpose. The average thickness of the backing layer is preferably 0.1 micrometers or greater but 20 micrometers or less, and more preferably 0.3 micrometers or greater but 10 micrometers or less.

—Underlying Layer—

The underlying layer is not particularly limited and may be appropriately selected depending on the intended purpose. The underlying layer includes an adhesive resin, and a hollow thermoplastic resin particles, and may further include other components according to the necessity.

The hollow thermoplastic resin particle includes a thermoplastic resin as a shell, and includes air inside the shell. Moreover, the hollow thermoplastic resin particle is a fine hollow particle in the form of foam.

The average particle diameter (external particle diameter) of the hollow thermoplastic resin particles is not particularly limited and may be appropriately selected depending on the intended purpose. The average particle diameter thereof is preferably 0.2 micrometers or greater but 20 micrometers or less, and more preferably 2 micrometers or greater but 5 micrometers or less.

When the average particle diameter is smaller than 0.2 micrometers, it is technically difficult to make the particles hollow, and therefore a function of the underlying layer does not exhibited. When the average particle diameter is greater than 20 micrometers, smoothness of the surface of the underlying layer after drying decreases and therefore more than a necessary amount of the thermosensitive recording layer coating liquid needs to be applied in order to make the surface thereof smooth.

Therefore, it is desired that the particles having a uniform distribution peak with a narrow particle size distribution are preferable as well as having the average particle diameter in the above-mentioned range.

The porosity of the hollow thermoplastic resin particles is not particularly limited and may be appropriately selected depending on the intended purpose. The porosity thereof is preferably from 50% through 95%, and more preferably from 80% through 95%.

When the porosity is less than 30%, thermal insulation is insufficient, and therefore thermal energy from a thermal head is released from the thermosensitive recording medium towards outside through the support and an effect of improving sensitivity becomes insufficient. The porosity is a ratio of the inner diameter (diameter of a pore) of hollow particles to the outer diameter of the hollow particles, and is represented by the following formula.

Porosity (%)=(inner diameter of hollow particles/outer diameter of hollow particles)×100

As described earlier, the hollow thermoplastic resin particles have shells of the thermoplastic resin. The thermoplastic resin is not particularly limited and may be appropriately selected depending on the intended purpose. Examples thereof include a styrene-acrylic resin, a polystyrene resin, an acrylic resin, a polyethylene resin, a polypropylene resin, a polyacetal resin, a chlorinated polyether resin, a polyvinyl chloride resin, and a copolymer resin mainly composed of vinylidene chloride and acrylonitrile. Among the above-listed examples, a styrene-acrylic resin, and a copolymer resin mainly composed of vinylidene chloride and acrylonitrile are preferable because particles thereof have a high porosity, have a small variation in particle diameters, and are suitable for blade coating.

Moreover, the thermoplastic material is not particularly limited and may be appropriately selected depending on the intended purpose. Examples thereof include phenolformaldehyde resins, urea-formaldehyde resins, melamine-formaldehyde resins, furan resins, an unsaturated polyester resin generated by addition polymerization, and a crosslinked MMA resin.

An application amount of the hollow thermoplastic resin particles is not particularly limited and may be appropriately selected depending on the intended purpose. In view of sensitivity and uniform coating, the application thereof is from 1 g through 3 g per square meter of the support. When the application amount thereof is less than 1 g/m², sufficient sensitivity cannot be obtained. When the application amount thereof is greater than 3 g/m², moreover, binding ability of the layer may be lowered.

An embodiment of the thermosensitive recording medium of the present disclosure is not particularly limited and may be appropriately selected depending on the intended purpose. For example, the thermosensitive recording medium may be used as it is as a label. Alternatively, a layer, onto which information, such as characters, marks, pictures, barcodes, or two-dimensional codes, such as QR codes (registered trademark) is printed, may be disposed on or above the protective layer or the support. Moreover, an embodiment thereof may be an embodiment where an adhesive layer is disposed at the side of the support opposite to the side thereof where the thermosensitive recording layer is disposed.

Moreover, a shape of the thermosensitive recording medium of the present disclosure is not particularly limited and may be appropriately selected depending on the intended purpose. Examples thereof include a label, a sheet, and a roll.

Specific examples of the embodiment of the thermosensitive recording medium of the present disclosure will be described hereinafter.

<Thermosensitive Recording Label>

The present embodiment of the thermosensitive recording medium is a thermosensitive recording label, which includes an adhesive layer disposed at the side of the support opposite to the side thereof at which the thermosensitive recording layer, and release paper disposed on the adhesive layer, and may further include other layers according to the necessity. The adhesive layer may be arranged on the entire area of the label, or a part of the label.

A material of the adhesive layer is not particularly limited and may be appropriately selected depending on the intended purpose. Examples thereof include a urea resin, a melamine resin, a phenol resin, an epoxy resin, a vinyl acetate resin, a vinyl acetateacryl copolymer, an ethylene-vinyl acetate copolymer, an acrylic resin, a polyvinyl ether resin, a vinyl chloride-vinyl acetate copolymer, a polystyrene resin, a polyester resin, a polyurethane resin, a polyamide resin, a chlorinated polyolefin resin, a polyvinyl butyral resin, acrylic acid ester copolymers, methacrylic acid ester copolymers, natural rubber, a cyanoacrylate resin, and a silicone resin. The above-listed examples may be used alone or in combination.

<Liner-Less Thermosensitive Recording Medium>

(with Release Layer)

The present embodiment of the thermosensitive recording medium is a liner-less thermosensitive recording medium, which further includes a release layer as an outermost layer at the side of the support at which the thermosensitive recording layer is disposed (surface side), and an adhesive layer at the opposite side of the support at which the thermosensitive recording layer is disposed (back side). Other layers may be disposed according to the necessity.

The release layer is preferably a layer formed of a material having excellent releasability from the adhesive layer, and particularly preferably a layer including silicone.

The present embodiment of the liner-less thermosensitive recording medium can be handled as a roll form, in which the thermosensitive recording medium is rolled in a manner that the adhesive layer is superimposed on the release layer.

(Without Release Layer)

The present embodiment of the thermosensitive recording medium is a liner-less thermosensitive recording medium, which further includes an adhesive layer at the opposite side of the support to the side thereof where the thermosensitive recording layer is disposed. The adhesive layer is a thermosensitive adhesive layer that exhibits adhesion by heating. The liner-less thermosensitive recording medium may further include other layers according to the necessity.

The thermosensitive adhesive layer includes a thermoplastic resin and a thermofusible material, and may further include a tackifier.

The thermoplastic resin is a material for imparting adhesion and bonding strength. Since the thermofusible material is a solid at room temperature, the thermofusible material does not impart plasticity to the resin, but exhibits adhesion as the thermofusible material is heated and fused to make the resin swell and soften. Moreover, the tackifier has a function of improving adhesion.

<Thermosensitive Magnetic Recording Paper>

The present embodiment of the thermosensitive recording medium is thermosensitive magnetic recording paper, which includes a magnetic recording layer disposed on a side of the support opposite to the side thereof at which the thermosensitive recording layer is disposed, and may further include other layers according to the necessity.

The magnetic recording layer may be formed by coating, on the substrate, materials including iron oxide or barium ferrite, and a vinyl chloride resin, a urethane resin, or a nylon resin, or by vapor deposition or sputtering without using a resin. The magnetic recording layer is preferably disposed at the opposite side of the support to the side thereof where the thermosensitive recording layer is disposed. The magnetic recording layer may be disposed between the support and the thermosensitive recording layer, or disposed on at least part of the thermosensitive recording layer.

(Recording Method)

A recording method using the thermosensitive recording medium of the present disclosure is not particularly limited and may be appropriately selected depending on the intended purpose. Examples thereof include a thermal head, and a laser.

The thermal head is not particularly limited and a shape, structure, and size thereof may be appropriately selected depending on the intended purpose.

The laser is not particularly limited and may be appropriately selected depending on the intended purpose. Examples thereof include a CO₂ laser and semiconductor laser emitting a wavelength of 9.3 micrometers or longer but 10.6 micrometers or shorter.

(Use)

Since the thermosensitive recording medium of the present disclosure has high coloring sensitivity and does not cause a reduction in sensitivity even after a long-term storage, the thermosensitive recording medium can be used in various fields, such as a POS field for fresh food products, packed meals, and premade meals; a copying field for books and documents; a telecommunication field, such as facsimiles; a ticketing field for ticket machines, and receipts; packaging tags for the aviation industry; pill cases; and pill bottles.

(Article)

The article of the present disclosure include the thermosensitive recording medium of the present disclosure.

As the thermosensitive recording medium, the thermosensitive recording medium of the present disclosure is suitably used.

The phrase “including the thermosensitive recording medium of the present disclosure” means a state where the thermosensitive recording medium of the present disclosure is adhered or mounted.

The article of the present disclosure is not particularly limited and may be appropriately selected depending on the intended purpose, as long as the article includes the thermosensitive recording medium of the present disclosure. Examples thereof include packing materials, packaging materials, and wrapping paper. More specific examples include packaging materials for fresh food products, packed meals, ready-made meals, books, and documents.

### EXAMPLES

The present disclosure will be described more specifically below by way of Examples. The present disclosure should not be construed as being limited to these Examples.

### Example 1

<Production of Thermosensitive Recording Medium>

—Preparation of Thermosensitive Recording Layer Coating Liquid [Liquid A]—

[Liquid B], [Liquid C], and [Liquid D] each having the following composition were dispersed and prepared by means of a sand grinder to give the average particle diameter of 0.5 micrometers [Liquid B], 1.0 micrometer [Liquid C], and 1.0 micrometer [Liquid D], respectively.

Next, 20 parts by mass of [Liquid B], 50 parts by mass of [Liquid C], 15 parts by mass of [Liquid D], 10 parts by mass of 10% by mass itaconic acid-modified polyvinyl alcohol aqueous solution, and 15 parts by mass of ion-exchanged water were mixed and stirred, to thereby prepare a thermosensitive recording layer coating liquid [Liquid A].

(Composition of Liquid B (Leuco Dye Dispersion Liquid))

Leuco dye (3-dibutylamino-6-methyl-7-anilinofluoran): 20 parts by mass

10% by mass itaconic acid-modified polyvinyl alcohol aqueous solution (25-88KL, available from KURARAY CO., LTD.): 40 parts by mass

Surfactant (Newcol 290, available from NIPPON NYUKAZAI CO., LTD., solid content: 100% by mass): 0.2 parts by mass

Ion-exchanged water: 40 parts by mass

(Composition of Liquid C (color developer dispersion liquid))

Color developer (N-[2-(3-phenylureide)phenyl]benzene sulfonamide, classification: non-phenolic color developer): 20 parts by mass

10% by mass itaconic acid-modified polyvinyl alcohol aqueous solution (25-88KL, available from KURARAY CO., LTD.): 20 parts by mass

Amorphous silica (MIZUKASIL P527, available from MIZUSAWA INDUSTRIAL CHEMICALS, LTD.): 15 parts by mass
Surfactant (PD-001, available from Nissin Chemical Co., Ltd., solid content: 100% by mass): 0.2 parts by mass

### Ion-Exchanged Water: 65 Parts by Mass

(Composition of Liquid D (Sensitizer Dispersion Liquid))

Sensitizer (stearic acid amide, product name: AP-1, available from Mitsubishi Chemical Corporation, classification: fatty acid amide): 25 parts by mass

10% by mass sulfone-modified polyvinyl alcohol aqueous solution (Gohselan L3266, available from Nippon Synthetic Chemical Industry Co., Ltd.): 25 parts by mass Surfactant (Newcol 290, available from NIPPON NYUKAZAI CO., LTD., solid content: 100% by mass): 0.2 parts by mass Ion-exchanged water: 50 parts by mass

—Preparation of Protective Layer Coating Liquid [Liquid E]—

Thirty parts by mass of aluminium hydroxide, 30 parts by mass of 10% by mass itaconic acid-modified polyvinyl alcohol (25-88KL, available from KURARAY CO., LTD.), and 40 parts by mass of ion-exchanged water were stirred and dispersed by means of a sand grinder to achieve the volume average particle diameter of 0.5 micrometers, to thereby obtain [Liquid F].

Subsequently, the materials of the following composition were mixed and stirred to thereby prepare a protective layer coating liquid [Liquid E].

(Composition of Liquid E (Protective Layer Coating Liquid))

Liquid F: 30 parts by mass

10% by mass diacetone-modified polyvinyl alcohol aqueous solution (DF-17, available from JAPAN VAM & POVAL CO., LTD.): 50 parts by mass

Crosslinking agent liquid (adipic acid dihydrazide, solid content: 10% by mass): 20 parts by mass

Montanic acid ester wax dispersion liquid (solid content: 30% by mass): 5 parts by mass

Ion-Exchanged Water: 15 Parts by Mass

—Preparation of Underlying Layer Coating Liquid [Liquid G]—

The materials of the following composition were mixed and stirred to thereby prepare an underlying layer coating liquid [Liquid G].

(Composition of Liquid G (Underlying Layer Coating Liquid))

Hollow particles (acrylonitrile-methacrylonitrile-isobornyl methacrylate copolymer, porosity: 90%, volume average particle diameter: 4.4 micrometers, solid content: 33% by mass): 20 parts by mass

Styrene/butadiene copolymer latex (solid content: 47.5% by mass): 20 parts by mass 10% by mass polyvinyl alcohol aqueous solution (PVA 117, available from KURARAY CO., LTD.): 20 parts by mass

### Ion-Exchanged Water: 40 Parts by Mass

Next, the underlying layer coating liquid [Liquid G] was applied onto a surface of a support that was paper having a basis weight of 60 g/m² to give a deposition amount of 3.0 g/m² after drying, followed by drying the coating liquid to thereby form an underlying layer. The thermosensitive recording layer coating liquid [Liquid A] was applied onto the underlying layer to give a deposition amount of 3.0 g/m² after drying, followed by drying the coating liquid to thereby form a thermosensitive recording layer. The protective layer coating liquid [Liquid E] was applied onto the thermosensitive recording layer to give a deposition amount of 2.5 g/m² after drying, followed by drying the coating liquid to thereby form a protective layer.

Next, a surface treatment was performed by super calendaring to give surface smoothness of from 1,500 seconds through 2,500 seconds, and the resultant was placed and sealed in a high-density polyethylene bag to cure in an environment of 40 degrees Celsius for the predetermined period.

### Example 2

A thermosensitive recording medium was produced in the same manner as in Example 1, except that the color developer was changed to Pergafast 201 (N-(p-toluenesulfonyl)-N′-(3-p-toluenesulfonyloxyphenyl)urea, available from BASF).

### Example 3

A thermosensitive recording medium was produced in the same manner as in Example 1, except that the color developer was changed to 18 parts by mass of NKK1304 (N-[2-(3-phenylureide)phenyl]benzene sulfonamide, available from Nippon Soda Co., Ltd.) and 2 parts by mass of UU (available from Chemipro Kasei Kaisha, Ltd.).

### Example 4

A thermosensitive recording medium was produced in the same manner as in Example 1, except that the color developer was changed to 18 parts by mass of Pergafast 201 (N-(p-toluenesulfonyl)-N′-(3-p-toluenesulfonyloxyphenyl)urea, available from BASF) and 2 parts by mass of UU (available from Chemipro Kasei Kaisha, Ltd.).

### Example 5

A thermosensitive recording medium was produced in the same manner as in Example 1, except that the sensitizer was changed to DIAMID KP (palmitic acid amide, available from Mitsubishi Chemical Corporation).

### Example 6

A thermosensitive recording medium was produced in the same manner as in Example 1, except that the sensitizer was changed to DIAMID KH (hydroxystearic acid amide, available from Mitsubishi Chemical Corporation).

### Example 7

A thermosensitive recording medium was produced in the same manner as in Example 1, except that Liquid D (sensitizer dispersion liquid) was changed to L-271 (stearic acid amide emulsion, available from CHUKYO YUSHI CO., LTD.).

### Example 8

A thermosensitive recording medium was produced in the same manner as in Example 1, except that Liquid D (sensitizer dispersion liquid) was changed to G-110 (ethylene bis stearic acid amide emulsion, available from CHUKYO YUSHI CO., LTD.).

### Example 9

A thermosensitive recording medium was produced in the same manner as in Example 1, except that Liquid D (sensitizer dispersion liquid) was changed to a sensitizer dispersion liquid including Liquid D and Liquid D2 below at the mass ratio (D:D2) of 80:20.

—Preparation of Liquid D2—

Liquid D2 was prepared in the same manner as the preparation of Liquid D of Example 1, except that the sensitizer was replaced with KS-235 (1,2-diphenoxyethane, available from SANKO CO., LTD.).

### Example 10

A thermosensitive recording medium was produced in the same manner as in Example 1, except that Liquid D (sensitizer dispersion liquid) was changed to a sensitizer dispersion liquid including Liquid D and Liquid D2 below at the mass ratio (D:D2) of 60:40.

### Example 11

A thermosensitive recording medium was produced in the same manner as in Example 1, except that [Liquid H] (release layer coating liquid) below was applied onto the protective layer to give a deposition amount of 1.0 g/m² after drying, followed by irradiating the release layer coating liquid with UV rays to cure the release layer coating liquid to thereby form a release layer. The release layer was rubbed with a finger to confirm that the release layer was not in the state of a liquid but it was cured.

—Preparation Example of Liquid H (Release Layer Coating Liquid)—

The materials of the following composition were stirred to thereby prepare [Liquid H].

Cationic curing UV silicone resin (Silicolease UV POLY215, available from ARAKAWA CHEMICAL INDUSTRIES, LTD.): 100 parts by mass

Light release adjuster (Silicolease RCA200, available from ARAKAWA CHEMICAL INDUSTRIES, LTD.): 15 parts by mass

Reaction initiator (Silicolease UV CATA211, available from ARAKAWA CHEMICAL INDUSTRIES, LTD.): 5 parts by mass

<Conditions of UV Ray Irradiation>

UV irradiator: TOSURE2000 (model name: KUV-20261-1X), available from TOSHIBA DENZAI CO., LTD.

UV irradiation conditions: Irradiation was performed 5 times in the total light state (from 10 A through 12 A as measured by an ammeter) at the irradiation rate of 5 m/min.

### Comparative Example 1

A thermosensitive recording medium was produced in the same manner as in Example 1, except that Liquid D (sensitizer dispersion liquid) was not used.

### Comparative Example 2

A thermosensitive recording medium was produced in the same manner as in Example 1, except that the sensitizer was changed to ST-LC (di(p-methylbenzyl)oxalate, available from Union).

### Comparative Example 3

A thermosensitive recording medium was produced in the same manner as in Example 1, except that the sensitizer was changed to DPS (diphenyl sulfone, available from UCB Japan Co., Ltd.).

### Comparative Example 4

A thermosensitive recording medium was produced in the same manner as in Example 1, except that the sensitizer was changed to KS-232 (1,2-bis(3-methylphenoxy)ethane, available from SANKO CO., LTD.).

### Comparative Example 5

A thermosensitive recording medium was produced in the same manner as in Example 1, except that the sensitizer was changed to KS-235 (1,2-diphenoxyethane, available from SANKO CO., LTD.).

### Comparative Example 6

A thermosensitive recording medium was produced in the same manner as in Example 1, except that the sensitizer was changed to BON (2-benzyloxynaphthalene, available from Cameleon).

### Comparative Example 7

A thermosensitive recording medium was produced in the same manner as in Example 1, except that Liquid D (sensitizer dispersion liquid) was changed to a sensitizer dispersion liquid including Liquid D and Liquid D2 at the mass ratio (D:D2) of 50:50.

### Comparative Example 8

A thermosensitive recording medium was produced in the same manner as in Example 1, except that Liquid D (sensitizer dispersion liquid) was changed to a sensitizer dispersion liquid including Liquid D and Liquid D2 at the mass ratio (D:D2) of 30:70.

### Comparative Example 9

A thermosensitive recording medium was produced in the same manner as in Example 11, except that the sensitizer was changed to KS-235 (1,2-diphenoxyethane, available from SANKO CO., LTD.).

TABLE 1

| | Thermosensitive recording layer | | | | | | |
|---|---|---|---|---|---|---|---|
| | Color | Color | Sensitizer 1 | | Sensitizer 2 | | |
| | developer 1 | developer 2 | | amount in total | | amount in total | |
| | product | product | product | sensitizers | product | sensitizers | Release |
| | name | name | name | (% by mass) | name | (% by mass) | layer |
| Ex. 1 | NKK1304 | — | AP-1 | 100 | — | — | — |
| Ex. 2 | Pergafast | — | AP-1 | 100 | — | — | — |
| | 201 | | | | | | |
| Ex. 3 | NKK1304 | UU | AP-1 | 100 | — | — | — |
| Ex. 4 | Pergafast | UU | AP-1 | 100 | — | — | — |
| | 201 | | | | | | |
| Ex. 5 | NKK1304 | — | D-KP | 100 | — | — | — |
| Ex. 6 | NKK1304 | — | D-KH | 100 | — | — | — |
| Ex. 7 | NKK1304 | — | L271 | 100 | — | — | — |
| Ex. 8 | NKK1304 | — | G110 | 100 | — | — | — |
| Ex. 9 | NKK1304 | — | AP-1 | 80 | KS-235 | 20 | — |
| Ex. 10 | NKK1304 | — | AP-1 | 60 | KS-235 | 40 | — |
| Ex. 11 | NKK1304 | — | AP-1 | 100 | — | — | present |
| Comp. | NKK1304 | — | — | — | — | — | — |
| Ex. 1 | | | | | | | |
| Comp. | NKK1304 | — | ST-LC | 100 | — | — | — |
| Ex. 2 | | | | | | | |
| Comp. | NKK1304 | — | DPS | 100 | — | — | — |
| Ex. 3 | | | | | | | |
| Comp. | NKK1304 | — | KS-232 | 100 | — | — | — |
| Ex. 4 | | | | | | | |
| Comp. | NKK1304 | — | KS-235 | 100 | — | — | — |
| Ex. 5 | | | | | | | |
| Comp. | NKK1304 | — | BON | 100 | — | — | — |
| Ex. 6 | | | | | | | |
| Comp, | NKK1304 | — | AP-1 | 50 | KS-235 | 50 | — |
| Ex. 7 | | | | | | | |
| Comp. | NKK1304 | — | AP-1 | 30 | KS-235 | 70 | — |
| Ex. 8 | | | | | | | |
| Comp. | NKK1304 | | KS-235 | 100 | — | — | present |
| Ex. 9 | | | | | | | |

The names of the manufacturers and products of the components presented in Table 1 above are as follows.

—Non-Phenolic Color Developer—

NKK1304: N-[2-[[(phenylamino)carbonyl]amino]phenyl]benzene sulfonamide, available from Nippon Soda Co., Ltd.

Pergafast 201:

4-methyl-N-[[[3-[[(4-methylphenyl)sulfonyl]oxy]phenyl]amino]carbonyl]benzene sulfonamide, available from BASF, the compound represented by Structural Formula (2) below
TG-MD: available from Nippon Kayaku Co., Ltd.
UU: the compound represented by Structural Formula (1) below, available from Chemipro Kasei Kaisha, Ltd.

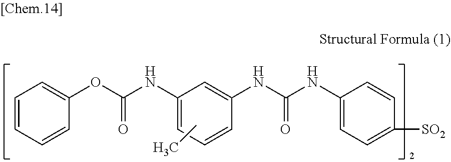

—Sensitizer—

—Sensitizer Classified as Fatty Acid Amide—

AP-1: stearic acid amide, available from Mitsubishi Chemical Corporation

DIAMID KP: palmitic acid amide, available from Mitsubishi Chemical Corporation

DIAMID KH: hydroxystearic acid amide, available from Mitsubishi Chemical Corporation

L271: stearic acid amide emulsion (solid content: 25%), available from CHUKYO YUSHI CO., LTD.

G110: ethylene bis stearic acid amide emulsion (solid content: 27.5%), available from CHUKYO YUSHI CO., LTD.

—Sensitizer not Classified as Fatty Acid Amide—

DPS: diphenyl sulfone, available from UCB Japan Co., Ltd.

ST-LC: di(p-methylbenzyl) oxalate, available from Union

KS-232: 1,2-bis(3-methylphenoxy)ethane, available from SANKO CO., LTD.

KS-235: 1,2-diphenoxyethane, available from SANKO CO., LTD.

BON: 2-benzyloxynaphthalene, available from Cameleon

Next, various properties of the produced thermosensitive recording media of Examples 1 to 9 and Comparative Examples 1 to 9 were evaluated in the following manner. The results are presented in Table 2.

<Coloring Sensitivity>

The produced thermosensitive recording medium was printed by a thermal printer (device name: MP-104T, available from MARKPOINT) at the printing speed of 100 mm/s with varying the printing energy in the range of from 0.96 mJ/mm² through 13.00 mJ/mm². The image density was measured by Macbeth reflection densitometer (device name: RD-914, available from Macbeth). The printing energy with which the image density became 1.0 was determined. The determined printing energy was used in the following formula to determine a sensitivity rate with using the printing energy of Comparative Example 1 as the standard. Note that, the lager value of the sensitivity indicates the better sensitivity (thermal response).

Sensitivity rate=(printing energy of Comparative Example 1)/(printing energy of each thermosensitive recording medium)

### <Evaluation Criteria>

A: The sensitivity rate was 1.20 or greater.
B: The sensitivity rate was greater than 1.00 but less than 1.20.
C: The sensitivity rate was 1.00 or less.

<Sensitivity Reduction>

As an adhesive, an acryl emulsion (AQUENCE PS AQ590 NACOR, available from Henkel Japan Ltd., solid content: 54% by mass) was applied at the opposite side of the support of each of the produced thermosensitive recording media to the side thereof where the thermosensitive recording layer to give a deposition amount of 20 g/m² after drying. In order to evaluate a change in recording sensitivity after storage over a long period, as an acceleration test, the thermosensitive recording medium was stored for 7 days in the environment of 40 degrees Celsius and 90% RH. Thereafter, the resultant was printed by a thermal printer (device name: MP-104T, available from MARKPOINT) at the printing speed of 100 mm/s with varying the printing energy in the range of from 0.96 mJ/mm² through 13.00 mJ/mm². The image density was measured by Macbeth reflection densitometer (device name: RD-914, available from Macbeth). The printing energy with which the image density became 1.0 was determined. The determined printing energy was used in the following formula to determine a sensitivity reduction rate with using the printing energy of Comparative Example 1 as the standard. Note that, the lager value of the sensitivity reduction rate indicates the better result.

Sensitivity reduction rate=(printing energy before storage)/(printing energy after storage)

<Evaluation Criteria>

A: The sensitivity reduction rate was 0.98 or greater.

B: The sensitivity reduction rate was 0.95 or greater but less than 0.98.

C: The sensitivity reduction rate was 0.90 or greater but less than 0.95.

D: The sensitivity reduction rate was less than 0.90.

TABLE 2

| | Coloring sensitivity | | Sensitivity reduction | |
|---|---|---|---|---|
| Evaluation | sensitivity | | sensitivity reduction | |
| result | rate | evaluation | rate | evaluation |
| Ex. 1 | 1.26 | A | 1.00 | A |
| Ex. 2 | 1.24 | A | 1.00 | A |
| Ex. 3 | 1.25 | A | 0.99 | A |
| Ex. 4 | 1.23 | A | 0.99 | A |
| Ex. 5 | 1.27 | A | 0.99 | A |
| Ex. 6 | 1.26 | A | 1.00 | A |
| Ex. 7 | 1.26 | A | 1.00 | A |
| Ex. 8 | 1.18 | B | 0.99 | A |
| Ex. 9 | 1.23 | A | 0.98 | A |
| Ex. 10 | 1.18 | B | 0.96 | B |
| Ex. 11 | 1.28 | A | 0.99 | A |
| Comp. | 1.00 | C | 1.00 | A |
| Ex. 1 | | | | |
| Comp. | 1.25 | A | 0.92 | C |
| Ex. 2 | | | | |
| Comp. | 1.26 | A | 0.91 | C |
| Ex. 3 | | | | |
| Comp. | 1.28 | A | 0.92 | C |
| Ex. 4 | | | | |
| Comp. | 1.08 | B | 0.85 | D |
| Ex. 5 | | | | |
| Comp. | 1.13 | B | 0.91 | C |
| Ex. 6 | | | | |
| Comp. | 1.12 | B | 0.93 | C |
| Ex. 7 | | | | |
| Comp. | 1.10 | B | 0.88 | D |
| Ex. 8 | | | | |
| Comp. | 1.12 | B | 0.83 | D |
| Ex. 9 | | | | |

Examples of the present disclosure are as follows.

<1> A thermosensitive recording medium including:

a support; and

a thermosensitive recording layer disposed on or above the support,

wherein the thermosensitive recording layer includes a non-phenolic color developer and a sensitizer that includes fatty acid amide, and

wherein an amount of the fatty acid amide in the sensitizer is 60% by mass or greater.

<2> The thermosensitive recording medium according to <1>,

wherein the amount of the fatty acid amide in the sensitizer is 80% by mass or greater.

<3> The thermosensitive recording medium according to <1> or <2>,

wherein the fatty acid amide is fatty acid monoamide.

<4> The thermosensitive recording medium according to any one of <1> to <3>, further including

an adhesive layer disposed at a side of the support opposite to a side of the support at which the thermosensitive recording layer is disposed.

<5> The thermosensitive recording medium according to any one of <1> to <4>, further including

a release layer disposed on or above the thermosensitive recording layer.

<6> The thermosensitive recording medium according to any one of <1> to <4>, further including

a protective layer disposed on or above the thermosensitive recording layer.

<7> The thermosensitive recording medium according to any one of <1> to <6>, further including

a leuco dye,
wherein an amount of the non-phenolic color developer is 1 part by mass or greater but 20 parts by mass or less, relative to 1 part by mass of the leuco dye.

<8> The thermosensitive recording medium according to any one of <1> to <7>, wherein the fatty acid amide is

4-methyl-N-[[[3-[[(4-methylphenyl)sulfonyl]oxy]phenyl]amino]carbonyl]benzenesulfonamide, N-[2-[[(phenylamino)carbonyl]amino]phenyl]benzenesulfonamide, or a compound represented by Structural Formula (1):

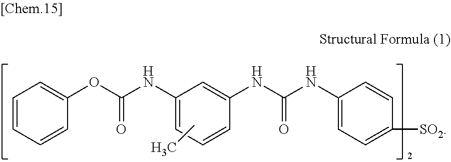

<9> A method for producing a thermosensitive recording medium, the method including

forming a thermosensitive recording layer which includes a support and a thermosensitive recording layer disposed on or above the support,
wherein the thermosensitive recording layer includes a non-phenolic color developer and a sensitizer that includes fatty acid amide, and
wherein an amount of the fatty acid amide in the sensitizer is 60% by mass or greater.

<10> The method according to <9>, further including

forming an adhesive layer at a side of the support opposite to aside of the support at which the thermosensitive recording layer is disposed.

<11> An article including

the thermosensitive recording medium according to any one of <1> to <8>.

The thermosensitive recording medium according to any one of <1> to <8>, the method for producing a thermosensitive recording medium according to <9> or <10>, and the article according to <11> can solve the above-described various problems existing in the art, and can achieve the object of the present disclosure.

1: A thermosensitive recording medium, comprising:
a support; and
a thermosensitive recording layer disposed on or above the support,
wherein the thermosensitive recording layer includes a non-phenolic color developer and a sensitizer that includes fatty acid amide, and
wherein an amount of the fatty acid amide in the sensitizer is 60% by mass or greater.

2: The thermosensitive recording medium according to claim 1, wherein the amount of the fatty acid amide in the sensitizer is 80% by mass or greater.

3: The thermosensitive recording medium according to claim 1, wherein the fatty acid amide is fatty acid monoamide.

4: The thermosensitive recording medium according to claim 1, further comprising:
an adhesive layer disposed at a side of the support opposite to a side of the support at which the thermosensitive recording layer is disposed.

5: The thermosensitive recording medium according to claim 1, further comprising:
a release layer disposed on or above the thermosensitive recording layer.

6: The thermosensitive recording medium according to claim 1, further comprising,
a protective layer disposed on or above the thermosensitive recording layer.

7: A method for producing a thermosensitive recording medium, the method comprising:
forming a thermosensitive recording medium which includes a support and a thermosensitive recording layer disposed on or above the support,
wherein the thermosensitive recording layer includes a non-phenolic color developer and a sensitizer that includes fatty acid amide, and
wherein an amount of the fatty acid amide in the sensitizer is 60% by mass or greater.

8: The method according to claim 7, further comprising:
forming an adhesive layer at a side of the support opposite to a side of the support at which the thermosensitive recording layer is disposed.

9: An article, comprising:
the thermosensitive recording medium according to claim 1.
